(19) United States
(12) Patent Application Publication
(10) Pub. No.: US 2024/0097169 A1
(43) Pub. Date: Mar. 21, 2024

(54) FUEL CELL SYSTEM

(71) Applicant: DENSO CORPORATION, Kariya-city (JP)

(72) Inventors: Takashi YAMADA, Kariya-city (JP); Masashi MAEDA, Nisshin-city (JP); Miho HATAZAKI, Nisshin-city (JP)

(21) Appl. No.: 18/512,510

(22) Filed: Nov. 17, 2023

Related U.S. Application Data
(63) Continuation of application No. PCT/JP2022/015894, filed on Mar. 30, 2022.

(30) Foreign Application Priority Data
May 21, 2021 (JP) 2021-086410

(51) Int. Cl. H01M 8/04858; H01M 8/04089; H01M 8/04746

(52) U.S. Cl. CPC H01M 8/0494; H01M 8/04089; H01M 8/04753

(57) ABSTRACT

A fuel cell system includes: a fuel cell that generates power by being supplied with a reaction gas; an air pressure regulator that regulates an air pressure, which is a pressure of an oxidant gas passing through the fuel cell; and a control device that controls a power generation amount of the fuel cell. When the air pressure is higher than a predetermined high-pressure reference value while a required output to the fuel cell shows a decreasing tendency, the control device limits or delays a reduction in the power generation amount of the fuel cell in response to a decrease in the required output. Alternatively, when the air pressure is lower than a predetermined low-pressure reference value while the required output to the fuel cell shows an increasing tendency, the control device limits or delays an increase in the power generation amount of the fuel cell.

### CROSS REFERENCE TO RELATED APPLICATION

The present application is a continuation application of International Patent Application No. PCT/JP2022/015894 filed on Mar. 30, 2022, which designated the U.S. and claims the benefit of priority from Japanese Patent Application No. 2021-086410 filed on May 21, 2021. The entire disclosures of all of the above applications are incorporated herein by reference.

### TECHNICAL FIELD

The present disclosure relates to a fuel cell system.

### BACKGROUND

In a battery system, a volumetric flow rate of reactant gas flowing into a fuel cell is estimated based on a delay time until the reactant gas reaches the fuel cell from means for supplying the reactant gas.

### SUMMARY

According to an aspect of the present disclosure, a fuel cell system includes: a fuel cell configured to generate power by being supplied with a reaction gas containing an oxidant gas; an air pressure regulator configured to regulate air pressure, which is a pressure of the oxidant gas passing through the fuel cell; and a control device configured to control a power generation amount of the fuel cell. When the air pressure is greater than a predetermined high-pressure reference value while the required output decreases, the control device limits or delays a reduction in the power generation amount of the fuel cell in accordance with a reduction in a required output required to the fuel cell. Alternatively, the control device limits or delays an increase in the amount of power generated by the fuel cell when the air pressure is lower than a predetermined low-pressure reference value while an output required to the fuel cell shows an increasing tendency.

### BRIEF DESCRIPTION OF THE DRAWINGS

FIG. 1 is a schematic configuration diagram of a fuel cell system according to a first embodiment;

FIG. 2 is a schematic block diagram showing a control device of the fuel cell system;

FIG. 3 is an explanatory diagram for explaining a relationship between an output voltage of a fuel cell and an air pressure;

FIG. 4 is a flowchart showing an example of control processing executed by the control device of the first embodiment;

FIG. 5 is a flowchart showing an example of power generation suppression processing executed by the control device of the first embodiment;

FIG. 6 is an explanatory diagram for explaining changes in the air pressure and the power generation amount of the fuel cell when the required output shows an increase trend;

FIG. 7 is a flowchart showing an example of air pressure adjustment process executed by the control device of the first embodiment;

FIG. 8 is an explanatory diagram for explaining changes in the air pressure and the power generation amount of the fuel cell when the required output shows a decrease trend;

FIG. 9 is a flow chart showing an example of power generation suppression processing executed by a control device of a second embodiment;

FIG. 10 is an explanatory diagram for explaining changes in the air pressure and the power generation amount of the fuel cell when the required output shows an increase trend;

FIG. 11 is a flow chart showing an example of air pressure adjustment process executed by the control device of the second embodiment; and

FIG. 12 is an explanatory diagram for explaining changes in the air pressure and the power generation amount of the fuel cell when the required output shows a decrease trend.

### DETAILED DESCRIPTION

Conventionally, a battery system is known in which a volumetric flow rate of reactant gas flowing into a fuel cell is estimated based on a delay time until the reactant gas reaches the fuel cell from the reactant gas supply means. The generated current of the fuel cell is limited according to the estimated volumetric flow rate.

Meanwhile, in the fuel cell system, it is desirable to operate the fuel cell in a state where the power generation performance is high from the viewpoint of improving the system efficiency. The power generation performance of the fuel cell changes according to the pressure of the oxidant gas inside the fuel cell (so-called air pressure). For example, when the air pressure inside the fuel cell is high, the power generation performance of the fuel cell tends to be high. When the air pressure inside the fuel cell is low, the power generation performance of the fuel cell tends to be low. This fact was found by the present inventors' intensive studies. The present disclosure provides a fuel cell system capable of improving system efficiency or a fuel cell system capable of suppressing a decrease in system efficiency.

According to an aspect of the present disclosure, a fuel cell system includes: a fuel cell configured to generate power by being supplied with a reaction gas containing an oxidant gas; an air pressure regulator configured to regulate air pressure, which is a pressure of the oxidant gas passing through the fuel cell; and a control device configured to control a power generation amount of the fuel cell. When the air pressure is greater than a predetermined high-pressure reference value while the required output decreases, the control device limits or delays a reduction in the power generation amount of the fuel cell in accordance with a reduction in a required output required to the fuel cell.

When the air pressure is high while the required output to the fuel cell shows a decreasing trend, if the amount of power generated by the fuel cell is reduced as the required output for the fuel cell decreases, the energy of the air pressure will be wasted.

When the air pressure is high while the required output to the fuel cell shows a decreasing trend, if the reduction in the amount of power generated by the fuel cell is limited or delayed in response to the decrease in the required output to the fuel cell, the energy of the air pressure can be recovered. In this case, since the time during which the fuel cell is operated with high power generation performance becomes longer, the system efficiency of the fuel cell system can be improved.

According to another aspect of the present disclosure, a fuel cell system includes: a fuel cell configured to generate power by being supplied with a reaction gas containing an oxidant gas; an air pressure regulator configured to regulate air pressure, which is a pressure of the oxidant gas passing through the fuel cell; and a control device configured to control a power generation amount of the fuel cell. The control device limits or delays an increase in the amount of power generated by the fuel cell when the air pressure is lower than a predetermined low-pressure reference value while an output required to the fuel cell shows an increasing tendency.

In a state where the air pressure is small, when the required output required to the fuel cell shows an increasing tendency, if the power generation amount of the fuel cell is increased in accordance with the increase in the required output, the fuel cell will continue to operate in a state where the power generation performance is low.

In a state where the air pressure is small, when the required output required to the fuel cell shows an increasing tendency, if the increase in the power generation amount of the fuel cell is limited or delayed, the operation of the fuel cell in the state where the power generation performance is low can be suppressed. Thus, a decrease in system efficiency of the fuel cell system can be suppressed.

The reference numerals in parentheses attached to the components and the like indicate an example of correspondence between the components and the like and specific components and the like in embodiments to be described below.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The respective embodiments described herein may be partially combined with each other as long as no particular problems are caused even without explicit statement of these combinations.

### First Embodiment

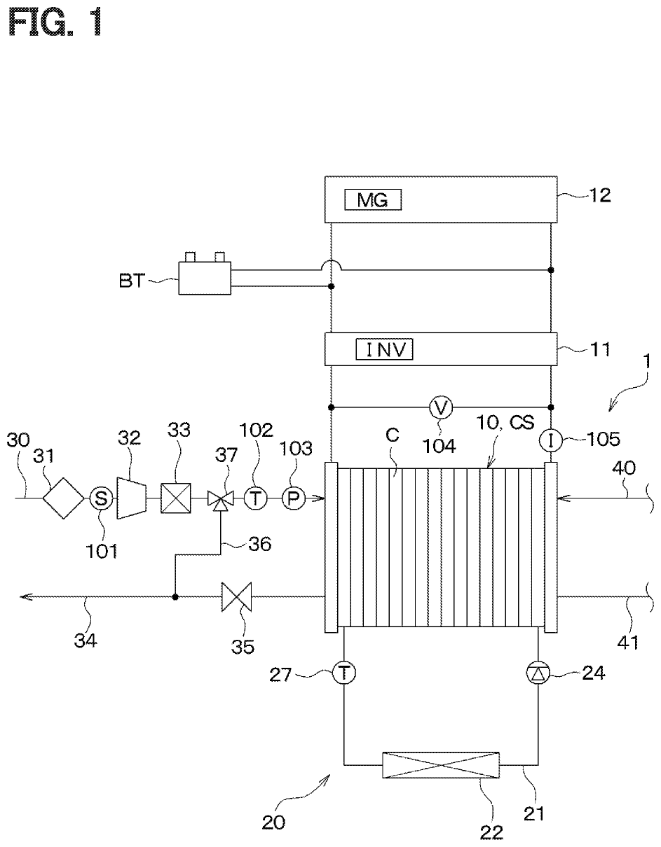

The present embodiment will be described with reference to FIGS. 1 to 8. In the present embodiment, a fuel cell system 1 of the present disclosure is applied to a vehicle FCV that obtains electric power necessary for driving the vehicle from a fuel cell 10. FCV is an abbreviation for Fuel Cell Vehicle.

The fuel cell system 1 includes the fuel cell 10 that uses an electrochemical reaction between hydrogen and oxygen to generate electric power. The fuel cell 10 supplies power to a power conversion device 11 such as an inverter INV. The inverter INV converts the DC current supplied from the fuel cell 10 into AC current and supplies the AC current to a load equipment 12 including a motor generator MG for driving, such that the load equipment 12 is driven.

The motor generator MG is configured by, for example, a three-phase AC rotating electric machine. The motor generator MG functions as an electric motor when power is supplied from the power conversion device 11, and functions as a generator that regenerates power when braking the vehicle FCV. Electric power generated by the motor generator MG is supplied to a power storage unit BT via the power conversion device 11.

The power storage unit BT is a battery electrically connected to the fuel cell 10 and can charge and discharge power. A lithium-ion capacitor is adopted as the power storage unit BT. A secondary battery such as a lithium-ion secondary battery or a nickel-metal hydride battery may be employed as the power storage unit BT. The fuel cell system 1 is configured such that surplus power and the like generated by the motor generator MG and/or output from the fuel cell 10 is stored in the power storage unit BT.

The fuel cell 10 is configured as a cell stack CS in which plural cells C are stacked, and the cell C is the minimum unit. The cell C is composed of a solid polymer electrolyte cell (so-called PEFC) having an electrolyte membrane, a catalyst, a gas diffusion layer, and a separator. In the cell C, the electrolyte membrane is supported by the catalyst, the gas diffusion layer, and the separator. In the cell C, when hydrogen is supplied to the anode electrode side and oxygen is supplied to the cathode electrode side, electrochemical reactions represented by the following reaction formulas F1 and F2 occur to generate electrical energy.

Anode electrode side: H₂→2H⁺+2e⁻ (F1)

Cathode electrode side: 2H⁺+½O₂+2e⁻→H₂O (F2)

In order for the above electrochemical reaction to occur, the electrolyte membrane of the cell C is in a wet state containing water. The fuel cell system 1 humidifies the electrolyte membrane inside the fuel cell 10. Humidification of the electrolyte membrane can be realized by arranging a humidifying device or the like in a path for supplying hydrogen, which is a fuel gas, or air, which is an oxidant gas.

The fuel cell system 1 has an air supply path 30 for supplying air containing oxygen, which is a reaction gas, toward the fuel cell 10. An air filter 31 is provided at the most upstream portion of the air supply path 30, and an air pump 32 is provided downstream of the air filter 31. The operation of the air pump 32 is controlled based on a control signal from a control device 100, which will be described later.

An intercooler 33 is arranged between the air pump 32 and the fuel cell 10. The intercooler 33 cools air pressurized by the air pump 32 by exchanging heat with the off-gas of the fuel cell 10 or cooling water.

The fuel cell system 1 has an air discharge path 34 for flowing the off-gas (that is, off-air) discharged from the fuel cell 10 to a muffler (not shown). An air valve 35 is provided in the air discharge path 34. The air valve 35 adjusts the air pressure, which is the pressure of the oxidant gas passing through the fuel cell 10, together with the air pump 32. The operation of the air valve 35 is controlled based on a control signal from the control device 100. In the fuel cell system 1 of this embodiment, the air pump 32 and the air valve 35 constitute an air pressure regulator that regulates the air pressure, which is the pressure of the oxidant gas passing through the fuel cell 10.

The fuel cell system 1 has a bypass path 36 that causes part of the air flowing through the air supply path 30 to bypass the fuel cell 10 and flows to the air discharge path 34. The bypass path 36 is provided to reduce the concentration of hydrogen in the off-fuel discharged from the muffler via a hydrogen discharge path 41, which will be described later. The bypass path 36 has one end connected between the intercooler 33 and the fuel cell 10 in the air supply path 30 and the other end connected downstream of the air valve 35 in the air discharge path 34. The bypass path 36 is provided with a three-way valve 37 at the connection with the air supply path 30. The three-way valve 37 is a flow control valve that adjusts the flow rate of the air flowing through the bypass path 36.

The fuel cell system 1 includes a hydrogen supply path 40 for supplying hydrogen, which is a reaction gas, toward the fuel cell 10. Although not shown, the hydrogen supply path 40 is provided with a high-pressure hydrogen tank at the most upstream portion, and a fuel valve at the downstream side of the high-pressure hydrogen tank.

The fuel cell system 1 includes the hydrogen discharge path 41 for flowing hydrogen off-gas (that is, off-fuel) discharged from the fuel cell 10 to a muffler (not shown). The hydrogen discharge path 41 is provided with an exhaust valve (not shown). The downstream side of the hydrogen discharge path 41 is connected to the air discharge path 34. As a result, the off-fuel flowing through the hydrogen discharge path 41 is mixed with the off-air and diluted, and then discharged from the muffler.

The fuel cell 10 generates heat due to an electrochemical reaction between hydrogen and oxygen. The operating temperature of the fuel cell 10 is maintained at about 80° C. in order to improve the power generation efficiency, suppress deterioration of the electrolyte membrane, and the like.

The fuel cell system 1 includes a cooling system 20 for adjusting the temperature of the fuel cell 10 to an appropriate temperature. The cooling system 20 adjusts the temperature of the fuel cell 10 by radiating heat of the fuel cell 10 to the outside and supplying heat from the outside to the fuel cell 10 using refrigerant.

The cooling system 20 includes a refrigerant channel 21 through which refrigerant for cooling the fuel cell 10 flows, a radiator 22, a refrigerant pump 24 and a refrigerant temperature sensor 27. The refrigerant channel 21 constitutes a circulation circuit for circulating the refrigerant between the radiator 22 and the fuel cell 10. The radiator 22 dissipates heat from the refrigerant that has passed through the fuel cell 10. The radiator 22 uses outside air as a heat medium and causes the refrigerant to radiate heat through heat exchange with the outside air. The refrigerant pump 24 pumps refrigerant toward the fuel cell 10. The refrigerant temperature sensor 27 detects the temperature of the refrigerant immediately after passing through the fuel cell 10.

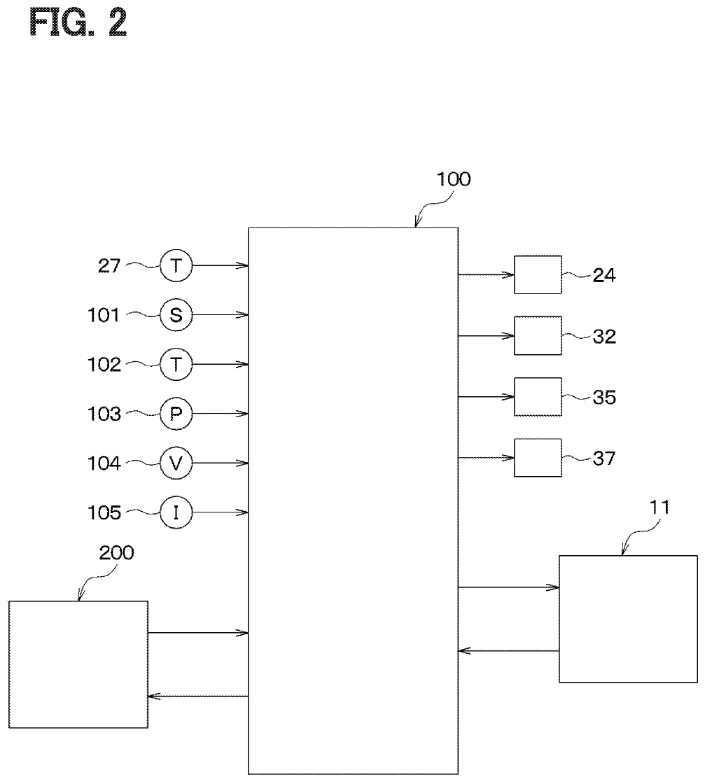

Next, the control device 100 of the fuel cell system 1 will be described with reference to FIG. 2. As shown in FIG. 2, the control device 100 controls the operation of various target devices of the fuel cell system 1. The control device 100 includes a processor, a microcomputer including memory, and its peripheral circuits. The memory of the control device 100 is a non-transitional tangible storage medium.

The input side of the control device 100 is connected with the refrigerant temperature sensor 27, the air flow meter 101, the air temperature sensor 102, the air pressure sensor 103, the FC voltage detector 104, and the FC current detector 105.

The air flow meter 101, the air temperature sensor 102 and the air pressure sensor 103 are arranged in the air supply path 30. The air flow meter 101 is a sensor that detects the flow rate of air supplied to the fuel cell 10 via the air supply path 30. The air temperature sensor 102 detects the temperature of air supplied to the fuel cell 10 via the air supply path 30. The air pressure sensor 103 detects the pressure of air supplied to the fuel cell 10 via the air supply path 30. The air pressure is an inlet side pressure of the oxidant gas in the fuel cell 10.

The FC voltage detector 104 and the FC current detector 105 are provided between the fuel cell 10 and the inverter INV. The FC voltage detector 104 is a sensor that detects the output voltage (that is, FC voltage) output by the fuel cell 10. The FC current detector 105 is a sensor that detects current flowing through the fuel cell 10.

Control target devices such as the refrigerant pump 24, the air pump 32, the air valve 35, the three-way valve 37, and the fuel valve (not shown) are connected to the output side of the control device 100. The control device 100 controls the operation of the fuel cell 10 by operating the control target devices connected to the output side based on a control program stored in the memory. That is, the control device 100 controls the control target devices including the air pump 32 and the air valve 35, and the power generation amount of the fuel cell 10.

The control device 100 is connected to the power conversion device 11 such as the inverter INV. Further, the control device 100 is connected to a vehicle ECU 200 via communication means such as CAN. The vehicle ECU 200 controls the vehicle FCV. The control device 100 receives a required output required to the fuel cell 10 from the vehicle ECU 200, and controls the control target device according to the required output.

In the fuel cell system 1 configured as described above, the control device 100 controls the operation of the control target device connected to the output side so that the fuel cell 10 outputs electric power corresponding to the required output.

Basically, when the required output to the fuel cell 10 is small, the control device 100 reduces the sweep current from the fuel cell 10 and controls the capacity of the air pump 32 and the degree of opening of the fuel valve so as to reduce the amount of hydrogen and air supplied to the fuel cell 10. Further, when the required output to the fuel cell 10 is large, the control device 100 increases the sweep current from the fuel cell 10 and controls the capacity of the air pump 32 and the degree of opening of the fuel valve so as to increase the amount of hydrogen and air supplied to the fuel cell 10.

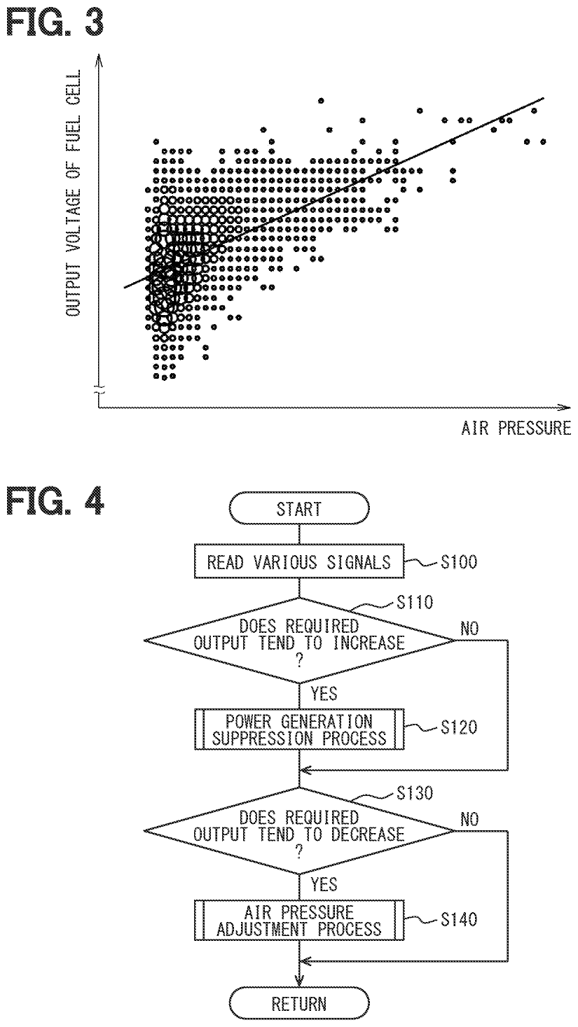

In the fuel cell system 1, from the viewpoint of improving system efficiency, it is desirable to operate the fuel cell 10 in a state where the power generation performance is high. The inventors verified the relationship between the power generation performance of the fuel cell 10 and the air pressure inside the fuel cell 10. FIG. 3 is an explanatory diagram for explaining the relationship between the output voltage of the fuel cell 10 and the air pressure. In FIG. 3, the horizontal axis indicates the air pressure, and the vertical axis indicates the output voltage of the fuel cell 10.

As shown in FIG. 3, the fuel cell 10 tends to increase the output voltage as the air pressure increases, and tends to decrease the output voltage as the air pressure decreases. The fuel cell 10 has a high output voltage when the power generation performance is better. Therefore, according to FIG. 3, it can be seen that the power generation performance of the fuel cell 10 increases as the air pressure increases.

In consideration of these, the control device 100 executes control processing for operating the fuel cell 10 in a state suitable for improving the power generation performance of the fuel cell 10. The control processing executed by the control device 100 will be described below with reference to FIG. 4 and the like. The control processing shown in FIG. 4 is periodically or irregularly executed by the control device 100 after the fuel cell 10 is activated.

As shown in FIG. 4, in step S100, the control device 100 reads various signals via devices connected to the input side of the control device 100, the vehicle ECU 200, and the like. The control device 100 reads detection values of various sensors, a required output to the fuel cell 10 from the vehicle ECU 200, and the like.

Subsequently, in step S110, the control device 100 determines whether or not the required output to the fuel cell 10 tends to increase. For example, when the current required output is greater than the previous required output, the control device 100 determines that the required output to the fuel cell 10 tends to increase. When the current required output is lower than or equal to the previous required output, the control device 100 determines that the required output to the fuel cell 10 does not tend to increase.

The control device 100 proceeds to step S120 and executes power generation suppression process when the required output of the fuel cell 10 tends to increase, and skips step S120 when the required output of the fuel cell 10 does not tend to increase.

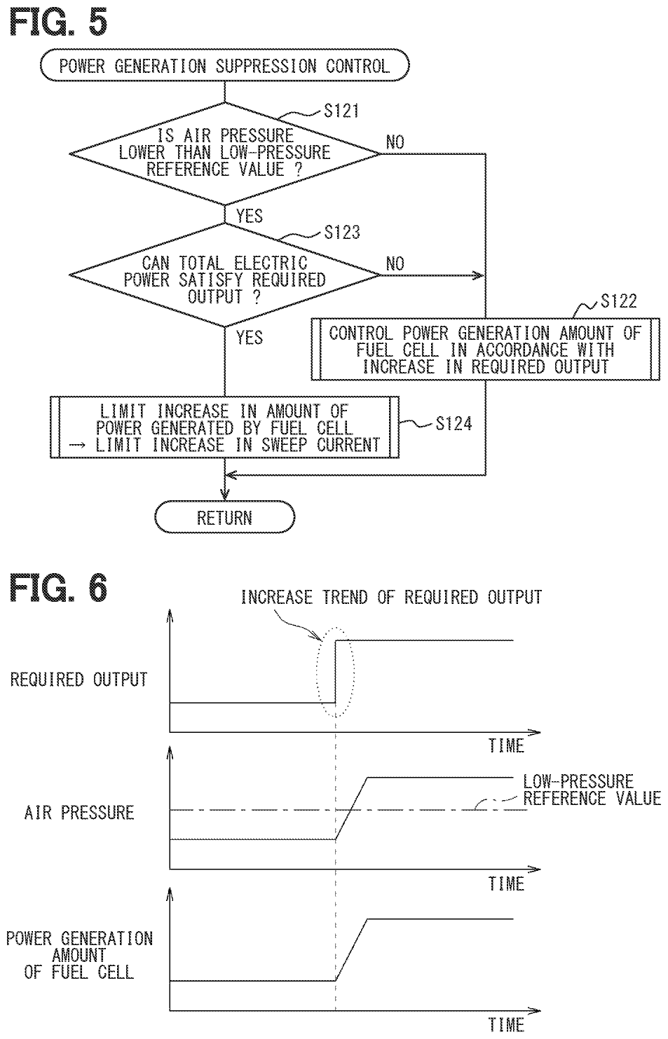

In the power generation suppression process, in case where the required output shows an increasing tendency, when the air pressure is lower than a low-pressure reference value, the control device 100 limits or delays an increase in the amount of power generated by the fuel cell 10 in response to an increase in the required output. Details of the power generation suppression process will be described below with reference to FIG. 5.

As shown in FIG. 5, in step S121, the control device 100 determines whether or not the air pressure is lower than a predetermined low-pressure reference value. The low-pressure reference value is set, for example, to a pressure value approximately equal to the air pressure determined according to the required output during steady operation of the fuel cell 10.

When the air pressure is equal to or higher than the low-pressure reference value, the control device 100 adjusts the power generation amount of the fuel cell 10, in step S122, in accordance with the required output to the fuel cell 10, and exits this process.

When the air pressure is lower than the low-pressure reference value, the control device 100, in step S123, determines whether or not a total power obtained by adding the power that can be supplied from the fuel cell 10 and the power that can be supplied from the power storage unit BT can satisfy the required output. That is, the control device 100 determines whether or not the required output can be satisfied with the power that can be output by the entire system. The control device 100, for example, calculates the power supplied from the fuel cell 10 based on the output voltage and the sweep current of the fuel cell 10, and adds the power accumulated in the power storage unit BT to the calculated power so as to obtain the total power.

If the power generation amount of the fuel cell 10 is limited when the total electric power cannot satisfy the required output, the running performance and drivability of the vehicle FCV may be affected. Therefore, when the total electric power cannot satisfy the required output, the control device 100 proceeds to step S122 to adjust the power generation amount of the fuel cell 10 according to the required output of the fuel cell 10, and exits this process.

When the total power can satisfy the required output, the control device 100 limits the increase in the amount of power generated by the fuel cell 10 in step S124, and exits this process.

The control device 100 of this embodiment limits an increase in the amount of power generated by the fuel cell 10 by limiting an increase in the sweep current from the fuel cell 10. The control device 100 limits the increase in sweep current from the fuel cell 10 by, for example, slowing down the increase speed of the sweep current from the fuel cell 10.

With such control processing, as shown in FIG. 6, when the air pressure is lower than the predetermined low-pressure reference value while the required output shows an increasing tendency, the power generation amount of the fuel cell 10 is restricted from increasing while the required output increases. That is, the power generation of the fuel cell 10 is suppressed when the air pressure is low.

Returning to FIG. 4, in step S130, the control device 100 determines whether or not the required output to the fuel cell 10 tends to decrease. For example, when the current required output is smaller than the previous required output, the control device 100 determines that the required output to the fuel cell 10 tends to decrease. When the current required output is more than or equal to the previous required output, the control device 100 determines that the required output to the fuel cell 10 does not tend to decrease.

The control device 100 proceeds to step S140 and executes an air pressure adjustment process when the required output to the fuel cell 10 tends to decrease, and skips step S140 when the required output of the fuel cell 10 does not tend to decrease.

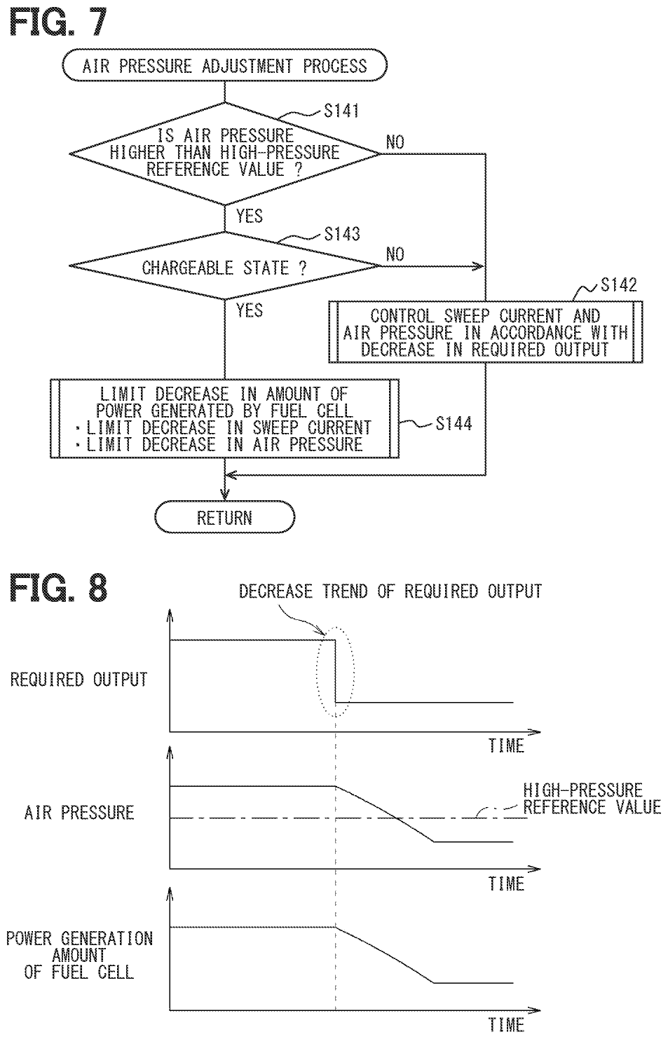

In the air pressure adjustment process, the control device 100 limits or delays the decrease in the power generation amount of the fuel cell 10 due to the decrease in the required output when the air pressure is higher than the high-pressure reference value while the required output shows a decreasing trend. Details of the air pressure adjustment process will be described below with reference to FIG. 7.

As shown in FIG. 7, in step S141, the control device 100 determines whether or not the air pressure is higher than a predetermined high-pressure reference value. The high-pressure reference value is set, for example, to a pressure value approximately equal to the air pressure determined according to the required output during steady operation of the fuel cell 10.

When the air pressure is equal to or lower than the high-pressure reference value, the control device 100 adjusts the sweep current and the air pressure in accordance with the required output to the fuel cell 10 in step S142, and exits this process.

When the air pressure is higher than the high-pressure reference value, the control device 100 determines in step S143 whether the power storage unit BT is in a chargeable state in which electric power output from the fuel cell 10 can be charged. The chargeable state includes, for example, at least one of the following: a state in which the motor generator MG is not regenerating power; a state in which the amount of regenerative power generated in the motor generator MG is equal to or less than a predetermined reference amount; or a state in which the free capacity of the power storage unit BT is equal to or greater than a predetermined reference capacity.

Heat is generated by the power storage unit BT during charging and discharging. From the viewpoint of preventing overheating of the power storage unit BT, it is desirable that the temperature of the power storage unit BT is within a normal temperature range. Therefore, the chargeable state includes a state in which the temperature of the power storage unit BT is equal to or lower than the predetermined reference temperature. According to this, since the overheating of the power storage unit BT can be prevented, it is possible to suppress deterioration and damage of the power storage unit BT caused by the overheating.

When the power storage unit BT is not in the chargeable state, even if a reduction in the power generation amount of the fuel cell 10 is restricted, the power cannot be stored in the power storage unit BT, and the power obtained by the power generation of the fuel cell 10 cannot be effectively used. Therefore, if the charging is not possible, the control device 100 proceeds to step S142 to adjust the sweep current and air pressure in accordance with the required output to the fuel cell 10, and exits this process.

When the power storage unit BT is in the chargeable state, the control device 100 adjusts the sweep current and the air pressure in step S144 so as to limit the decrease in the amount of power generated by fuel cell 10, and exits this process.

The control device 100 of this embodiment limits the decrease in the amount of power generated by the fuel cell 10 by limiting the decrease in the sweep current according to the required output and the decrease in the air pressure according to the required output. The control device 100 limits the decrease in the sweep current from the fuel cell 10 by, for example, slowing down the decrease speed of the sweep current from the fuel cell 10. The control device 100 may, for example, limit the amount of decrease in the discharge capacity of the air pump 32 per unit time, or limit the amount of increase in the opening degree of the air valve 35 per unit time, thereby limiting the decrease in the air pressure. The opening degree of the air valve 35 represents the opening degree of the passage through which the fluid flows in the air valve 35. The passage of the air valve 35 becomes narrower as the opening degree is smaller, and the passage becomes wider as the opening degree of is larger.

With such control processing, as shown in FIG. 8, when the air pressure is greater than the predetermined high-pressure reference value while the required output shows a decreasing tendency, the amount of power generated by the fuel cell 10 is restricted from decreasing while the required output decreases. That is, the power generation of the fuel cell 10 is continued in a state where the air pressure is high.

In the fuel cell system 1 described above, when the air pressure is high while the required output of the fuel cell 10 shows a decreasing trend, if the power generation amount of the fuel cell 10 decreases as the required output of the fuel cell 10 decreases, the energy of air pressure is wasted. Taking this into account, when the air pressure is higher than the high-pressure reference value while the required output shows a decreasing trend, the control device 100 limits the decrease in the power generation amount of the fuel cell 10 in response to the decrease in the required output, compared with the otherwise case. According to this, it is possible to recover the energy of the air pressure when the required output required of the fuel cell 10 shows a decreasing tendency. In this case, the time for which the fuel cell 10 is operated with high power generation performance becomes longer, so the system efficiency of the fuel cell system 1 can be improved.

Further, according to the present embodiment, the following advantages can be obtained.

(1) The control device 100 controls at least one of the air pump 32 or the air valve 35 to limit the decrease in the air pressure when the air pressure is higher than the high-pressure reference value while the required output shows a decreasing tendency. According to this, it is possible to improve the system efficiency of the fuel cell system 1 by operating the fuel cell 10 with high power generation performance.

(2) When the air pressure is higher than the high-pressure reference value while the required output shows a decreasing trend and the charging in the power storage unit BT is possible, the control device 100 limits the decrease in the power generation amount of the fuel cell 10 as the required output decreases. According to this, the surplus power generated by limiting the decrease in the amount of power generated by the fuel cell 10 can be recovered in the power storage unit BT.

(3) The chargeable state includes a state in which the temperature of the power storage unit BT is equal to or lower than a predetermined reference temperature. According to this, it is possible to suppress overheating of the power storage unit BT due to the restriction or delay in the decrease in the amount of power generated by the fuel cell 10.

(4) When the air pressure is lower than the predetermined low-pressure reference value while the required output shows an increasing tendency, the control device 100 limits the increase in the amount of power generated by the fuel cell 10 compared to when the air pressure is not lower than the predetermined low-pressure reference value. According to this, since the operation of the fuel cell 10 is suppressed in the state where the power generation performance is low, the deterioration in the system efficiency of the fuel cell system 1 can be suppressed.

(5) The control device 100 limits the increase in the power generation amount of the fuel cell 10 when the air pressure is lower than the low-pressure reference value while the required output shows an increasing tendency, and the required output can be satisfied by the total electric power. According to this, it is possible to suppress the deterioration of the system efficiency of the fuel cell system 1 while suppressing the power shortage due to the restriction on the increase in the amount of power generated by the fuel cell 10.

### Second Embodiment

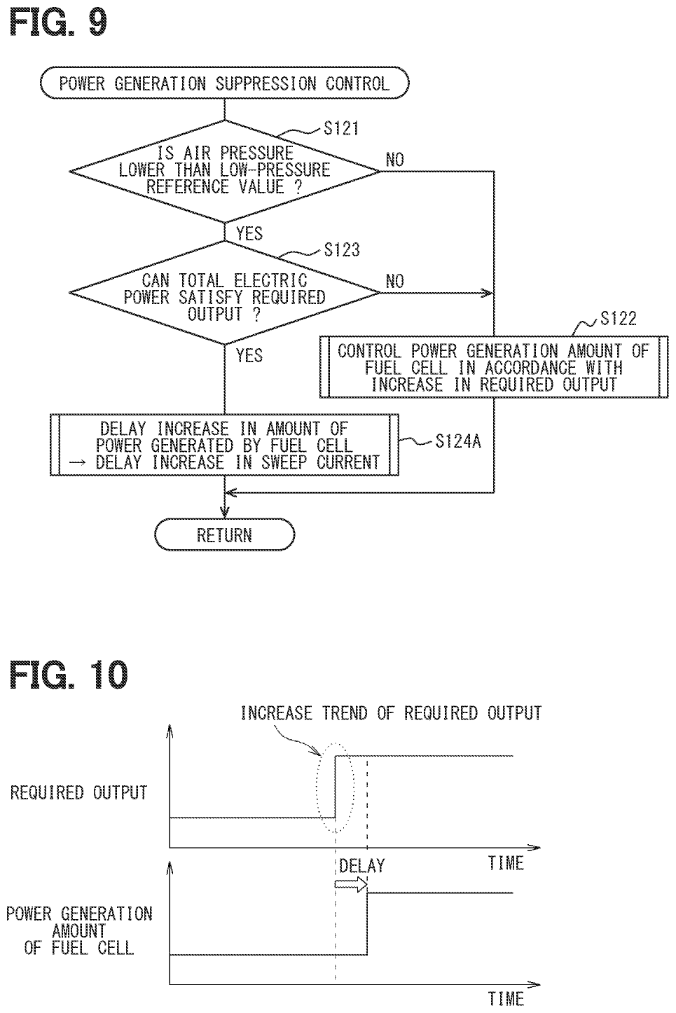

Next, a second embodiment will be described with reference to FIGS. 9 to 12. In the present embodiment, differences from the first embodiment will be mainly described. The fuel cell system 1 of this embodiment differs from that of the first embodiment in part of the power generation suppression process and part of the air pressure adjustment process executed by the control device 100.

In the power generation suppression process of this embodiment, an increase in the power generation amount of the fuel cell 10 is delayed when the air pressure is lower than the low-pressure reference value while the required output shows an increasing tendency. Details of the power generation suppression process will be described below with reference to FIG. 9. Note that the processing from steps S121 to S123 shown in FIG. 9 is the same as the processing from steps S121 to S123 shown in FIG. 5.

As shown in FIG. 9, when the air pressure is lower than the low-pressure reference value while the required output shows an increasing tendency and the total electric power can satisfy the required output, the control device 100, in step S124A, delays the increase in the amount of power generated by the fuel cell 10, and exits from this process.

The control device 100 of this embodiment delays the increase in the amount of power generated by the fuel cell 10 by delaying the increase in the sweep current from the fuel cell 10. The control device 100 delays the increase in the power generation amount of the fuel cell 10 by, for example, delaying the timing of increasing the sweep current from the fuel cell 10.

With such a control process, as shown in FIG. 10, when the air pressure is lower than the predetermined low-pressure reference value while the required output shows an increasing tendency, the increase in the power generation amount of the fuel cell 10 is delayed as the required output increases.

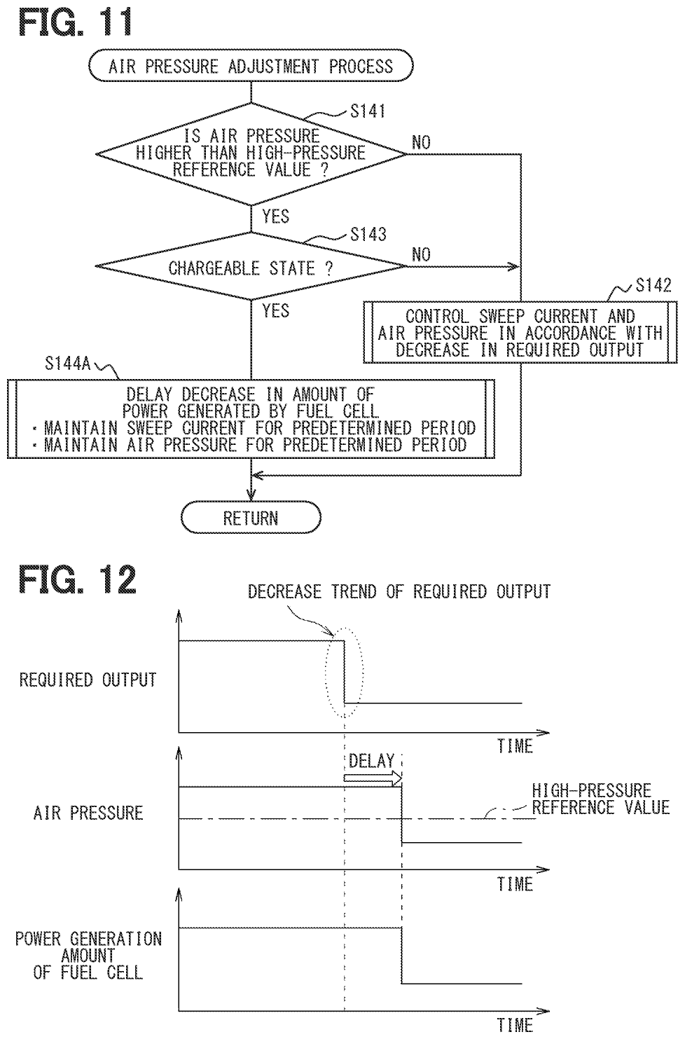

Further, in the air pressure adjustment process, the decrease in the power generation amount of the fuel cell 10 due to the decrease in the required output is delayed when the air pressure is higher than the high-pressure reference value while the required output shows a downward trend. Details of the air pressure adjustment process will be described below with reference to FIG. 11. The processing from steps S141 to S143 shown in FIG. 11 is the same as the processing from steps S141 to S143 shown in FIG. 7.

As shown in FIG. 11, when the air pressure is lower than the high-pressure reference value while the required output shows a downward trend and the charging is possible, the control device 100 proceeds to step S144A. In step S144A, the control device 100 adjusts the sweep current and the air pressure so that the decrease in the amount of power generated by fuel cell 10 is delayed, and exits this process.

The control device 100 of the present embodiment delays the reduction in the amount of power generated by the fuel cell 10 by delaying the reduction in the sweep current and the air pressure in accordance with the required output. The control device 100 delays the reduction of the sweep current from the fuel cell 10 by, for example, delaying the timing of reducing the sweep current from the fuel cell 10. The control device 100 delays the reduction in the air pressure by, for example, delaying the timing of reducing the discharge capacity of the air pump 32 or delaying the timing of changing the throttle opening of the air valve 35.

With such control processing, as shown in FIG. 12, when the air pressure is greater than the predetermined high-pressure reference value while the required output shows a decreasing tendency, the decrease in the power generation amount of the fuel cell 10 is delayed as the required output decreases.

The others are the same as those in the first embodiment. The fuel cell system 1 of this embodiment can obtain the same effects as those of the first embodiment due to the same or equivalent structure as that of the first embodiment.

Further, according to the present embodiment, the following advantages can be obtained.

(1) The control device 100 controls at least one of the air pump 32 or the air valve 35 so that the air pressure is maintained for a predetermined period when the air pressure is higher than the high-pressure reference value while the required output shows a decreasing tendency. According to this, it is possible to improve the system efficiency of the fuel cell system 1 by operating the fuel cell 10 with high power generation performance.

(2) When the air pressure is higher than the high-pressure reference value while the required output shows a decreasing trend and the charging is possible, the control device 100 delays the decrease in the power generation of the fuel cell 10 as the required output decreases. According to this, the surplus power generated by limiting the decrease in the amount of power generated by the fuel cell 10 can be recovered in the power storage unit BT.

(3) The control device 100 delays an increase in the power generation amount of the fuel cell 10 when the air pressure is lower than the predetermined low-pressure reference value while the required output shows an increasing tendency. According to this, the operation of the fuel cell 10 is suppressed when the power generation performance is low, so the deterioration in the system efficiency of the fuel cell system 1 can be suppressed.

(4) The control device 100 delays the increase in the power generation amount of the fuel cell 10 when the air pressure is lower than the low-pressure reference value while the required output shows an increasing tendency and the required output can be satisfied by the total electric power. According to this, it is possible to suppress the deterioration of the system efficiency of the fuel cell system 1 while suppressing the power shortage due to the delay in the increase of the power generation amount of the fuel cell 10.

### OTHER EMBODIMENT

The present disclosure is not limited to the typical embodiments of the present disclosure described herein, but may include various modifications, such as following configurations.

As in the above-described embodiment, it is desirable that the control device 100 changes the power generation amount of the fuel cell 10 when the air pressure is higher than the high-pressure reference value while the required output tends to decrease and when the air pressure is lower than the low-pressure reference value while the required output tends to increase.

However, the control device 100 may change the power generation amount of the fuel cell 10 only when the air pressure is higher than the high-pressure reference value while the required output shows a downward trend. Further, the control device 100 may change the power generation amount of the fuel cell 10 only when the air pressure is lower than the low-pressure reference value while the required output shows an increasing tendency.

When the air pressure is higher than the high-pressure reference value while the required output shows a decreasing trend, regardless of whether or not the power storage unit BT is in a chargeable state, the control device 100 may limit or delay the reduction in the power generation of the fuel cell 10 in accordance with the decrease in the required output. It should be noted that the control device 100 may limit and delay the decrease in the power generation amount of the fuel cell 10 in a manner different from that described above.

Regardless of whether or not the total electric power satisfies the required output, the control device 100 may limit or delay the increase in the amount of power generated by the fuel cell 10 in response to the increase in the required output when the air pressure is lower than the low-pressure reference value while the required output shows an increasing tendency. It should be noted that the limit and delay of the increase in the power generation amount of the fuel cell 10 by the control device 100 may be implemented in a manner different from that described above.

In the embodiment, the fuel cell system 1 of the present disclosure is applied to a vehicle FCV, but the fuel cell system 1 of the present disclosure can be applied to other than the vehicle FCV.

In the embodiments, it is needless to say that the elements configuring the embodiments are not necessarily essential except in the case where those elements are clearly indicated to be essential in particular, the case where those elements are considered to be obviously essential in principle, and the like.

In the embodiments, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments, when a shape, a positional relationship, or the like of the component or the like is mentioned, the shape, the positional relationship, or the like is not limited to that being mentioned unless otherwise specified or limited to a specified shape, a specified positional relationship, or the like in principle.

The control device and method of the present disclosure is implemented on a dedicated computer provided by configuring a processor and memory programmed to perform one or more functions embodied by the computer program. The control device and method of the present disclosure may be implemented in a dedicated computer provided by configuring the processor with one or more dedicated hardware logic circuits. The controller and method described in the present disclosure may be implemented by a combination of (i) a special purpose computer including a processor programmed to execute one or more functions by executing a computer program and a memory and (ii) a special purpose computer including a processor with one or more dedicated hardware logic circuits. The computer program may be stored in a computer-readable non-transitory tangible recording medium as an instruction executed by a computer.

What is claimed is:

1. A fuel cell system comprising:
a fuel cell configured to generate power by being supplied with a reaction gas containing an oxidant gas;
an air pressure regulator configured to regulate an air pressure, which is a pressure of the oxidant gas passing through the fuel cell; and
a control device configured to control a power generation amount of the fuel cell, wherein
when the air pressure is greater than a predetermined high-pressure reference value while a required output required to the fuel cell shows a decreasing tendency, the control device limits or delays a reduction in the power generation amount of the fuel cell in response to a decrease in the required output.

2. The fuel cell system according to claim 1, wherein
the control device controls the air pressure regulator such that the air pressure is maintained for a predetermined period of time or a reduction in the air pressure is limited when the air pressure is higher than the high-pressure reference value while the required output shows a decreasing tendency.

3. The fuel cell system according to claim 1, further comprising: a power storage unit electrically connected to the fuel cell so as to charge and discharge electric power, wherein
when the air pressure is higher than the high-pressure reference value while the required output shows a decreasing tendency and when a power output from the fuel cell is chargeable to the power storage unit, the control device limits or delays a decrease in the power generation amount of the fuel cell in response to the decrease in the required output.

4. The fuel cell system according to claim 1, wherein
the control device limits or delays an increase in the power generation amount of the fuel cell when the air pressure is lower than a predetermined low-pressure reference value while the required output shows an increasing tendency.

5. A fuel cell system comprising:
a fuel cell configured to generate power by being supplied with a reaction gas containing an oxidant gas;
an air pressure regulator configured to regulate an air pressure, which is a pressure of the oxidant gas passing through the fuel cell; and
a control device configured to control a power generation amount of the fuel cell, wherein
when the air pressure is lower than a predetermined low-pressure reference value while a required output required to the fuel cell shows an increasing tendency, the control device limits or delays an increase in the power generation amount of the fuel cell.

6. The fuel cell system according to claim 5, further comprising: a power storage unit electrically connected to the fuel cell so as to charge and discharge electric power, wherein
the control device limits or delays an increase in the power generation amount of the fuel cell when the air pressure is lower than the low-pressure reference value while the required output shows an increasing tendency and when the required output is satisfied by a total power of a power to be supplied from the fuel cell and a power to be supplied from the power storage unit.
